(19) United States
(12) Patent Application Publication
(10) Pub. No.: US 2025/0277740 A1
(43) Pub. Date: Sep. 4, 2025

(54) DEVICE FOR EXAMINING MATERIAL SAMPLES BY MEANS OF ELECTROMAGNETIC RADIATION WITH SELECTABLE DETECTOR

(71) Applicant: Nova Industrial Analytics GmbH, Eschach (DE)

(72) Inventor: Joachim MANNHARDT, Eschach (DE)

(73) Assignee: Nova Industrial Analytics GmbH, Eschach (DE)

(21) Appl. No.: 19/203,121

(22) Filed: May 8, 2025

Related U.S. Application Data
(63) Continuation of application No. PCT/EP2023/081138, filed on Nov. 8, 2023.

(30) Foreign Application Priority Data
Nov. 8, 2022 (DE) 10 2022 129 497.8

(51) Int. Cl. G01N 21/64

(52) U.S. Cl. CPC G01N 21/645; G01N 2021/6463; G01N 2201/062; G01N 2201/0636; G01N 2201/0666; G01N 2201/0806

(57) ABSTRACT

A device for examining material samples via electromagnetic radiation. The device comprises a lighting unit for generating the electromagnetic radiation with at least two radiation sources. The radiation of the radiation sources can be selectively directed onto the material sample. The device further comprises a detection unit having at least two detectors for capturing electromagnetic radiation emanating from the material sample. A deflection element is arranged in the detection unit, via which the electromagnetic radiation emanating from the material sample can be selectively deflected onto one of the detectors. This deflection element comprises a mirror, via which the radiation emanating from the material sample can be selectively deflected onto one of the detectors. The mirror is rotated about an axis extending substantially perpendicular to the optical axes of the detectors.

This nonprovisional application is a continuation of International Application No. PCT/EP2023/081138, which was filed on Nov. 8, 2023, and which claims priority to German Patent Application No. 10 2022 129 497.8, which was filed in Germany on Nov. 8, 2022, and which are both herein incorporated by reference.

### BACKGROUND OF THE INVENTION

### Field of the Invention

The invention relates to an apparatus for examining material samples via electromagnetic radiation.

### Description of the Background Art

In many fields of industry pertaining to production and further processing, for example medical engineering, the food industry, etc., optical measuring methods are used to assess the state or quality of a product or an intermediate product. The term “optical measuring method” should be understood hereinafter to mean a measuring method using electromagnetic radiation, in particular electromagnetic radiation in a spectral range between infrared and ultraviolet. “Optical measurement” thus includes in particular a measurement in the far infrared (FIR), mid-infrared (MIR) and near infrared (NIR) spectral ranges, in the visible spectral range and in the UV range.

Such measurements are often associated with the desire to examine the material sample using electromagnetic radiation of different wavelengths. By way of example, for performing fluorescence measurements, biochemical samples can be labeled with two or more fluorophores, such that they emit light differently upon excitation with different light wavelengths. Biochemical properties can be measured in this way.

DE 699 29 086 T2 discloses a measuring device having a radiation source and a detector module, in which the radiation source transmits a combined beam made of UV and IR radiation, and the detector module comprises a plurality of individual detectors. By means of a rotary mirror arranged in the interior of the detector module, the radiation received by the detector module can be sequentially steered to the individual detectors without being split in the process.

### SUMMARY OF THE INVENTION

The problem addressed by the present invention is that of developing the measuring apparatus known from the prior art, in such a way that an accurate assignment of the radiation measured in a predetermined spectral range to a spectral range of the excitation radiation is ensured. Furthermore, the apparatus should allow a quick and simple change between different spectral measurement regions.

An apparatus according to an example of the invention comprises an illumination device for generating electromagnetic radiation and a detection device having at least two detectors for capturing an electromagnetic radiation emanating from the material sample. The illumination device comprises at least two radiation sources such that the radiation from one radiation source or the radiation from the other radiation source may be selectively directed at the material sample. The detection device comprises a deflection element by means of which the radiation emanating from the material sample may be selectively steered onto one of the detectors. According to the invention, this deflection element of the illumination device comprises a rotatable mirror by means of which the radiation may be selectively steered onto one of the detectors.

The design according to the invention of the apparatus is advantageous in that a plurality of radiation sources may be provided, the radiation of which may be used to illuminate the material sample. The apparatus according to the invention is particularly suitable for fluorescence analysis, in which the material sample is excited by polychromatic radiation or radiation in a limited spectral range, and the fluorescence radiation emitted by the material sample in a predetermined direction in the process is evaluated with the aid of the detection device.

In a first configuration of the invention, at least two of the radiation sources can have identical structures. This enables a redundant illumination, in particular in problematic surroundings, in which for example incandescent filaments of halogen lamps or anodes of mercury vapor lamps may crack or break off owing to mechanical loading, vibrations, etc.

Further, at least two of the radiation sources can have different structures, for example radiate in different spectral ranges, with different intensities, etc. This makes it possible to choose a radiation source that is optimally suitable for the respective measurement task. Furthermore, this allows a quick switchover between the radiation sources if radiation at different wavelengths should be successively steered onto the material sample for a given measurement task.

In particular, LED diodes transmitting in a predetermined spectral range may be used as radiation sources. In an alternative, use might be made of halogen lamps, for example, the radiation of which can be restricted to a predetermined spectral range by a filter.

The illumination device advantageously comprises a deflection element with the aid of which the radiation from one radiation source or the other may be selectively steered onto the material sample. This deflection element is designed such that it allows a quick switch-off or switch-on of the different radiation sources without complicated adjustment work being required within the scope of changing the radiation source.

The deflection element of the illumination device advantageously has beam-shaping properties. For example, the deflection element can be designed such that it focuses the radiation emitted by the respective radiation source onto the material sample; in particular, such a configuration is advantageous should thee intention be to examine small objects. In an alternative, the deflection element may expand (defocus) the beam emitted by the radiation source, which may for example be advantageous in applications of reflection spectroscopy in the visible or infrared spectral range, when the intention is to illuminate the material sample over a large area.

The deflection element of the illumination device may comprise a mirror in particular, by means of which the one or the other radiation source may be selectively steered onto the material sample. For example, use may be made of a concave mirror, in particular a parabolic mirror, which has a collimation effect that is advantageous for spectroscopic measurements.

Expediently, the deflection element of the illumination device is rotatably mounted, to be precise in such a way that the axis of rotation is aligned parallel to the propagation direction of the deflected radiation. In this case, the two or more radiation sources may be arranged on a circular arc around the deflection element, and rotations of the deflection element allow the radiation from the one or the other radiation source to be selectively steered onto the material sample without further adjustments being required.

The deflection element of the illumination device may have an opening for passing through electromagnetic radiation. This is expedient, in particular, should the spectrum of the intensity of the radiation reflected off the material sample in the direction of incidence be measured, for example within the scope of determining the intensity or checking the functionality in transmission measurements. Furthermore, it is advantageous to provide an optical waveguide, in particular a light-guiding rod, which guides the radiation reflected off the material sample in the direction of incidence through the deflection element of the illumination device with low losses, in the region of this passage opening.

To allow fluorescence measurements in different spectral ranges in quick temporal succession, it is advantageous to synchronize the switch-on and switch-off of the various radiation sources of the illumination device with the switch-on and switch-off of the different detectors of the detection device. In this way, a plurality of measurements in different spectral ranges may be performed on the material sample in quick succession.

If, as described above, the illumination device is provided with a deflection element by means of which radiation from a specific radiation source may be selectively steered onto the material sample, then it is advantageous to synchronize the movements of this deflection element with the movements of the deflection element of the detection device such that the radiation source active at a given time corresponds to the associated detector.

In a manner analogous to the configuration of the deflection element of the illumination device, the deflection element of the detection device may also have beam-shaping properties by way of for example focusing the radiation emanating from the material sample onto the detectors.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic sectional view of an apparatus for examining material samples, having a plurality of light sources and a plurality of detectors;

FIG. 2 shows a schematic sectional view of a further apparatus for examining material samples, having a plurality of light sources and a plurality of detectors; and

FIG. 3 shows a schematic sectional view of an alternative apparatus for examining material samples, having a plurality of light sources and a plurality of detectors.

### DETAILED DESCRIPTION

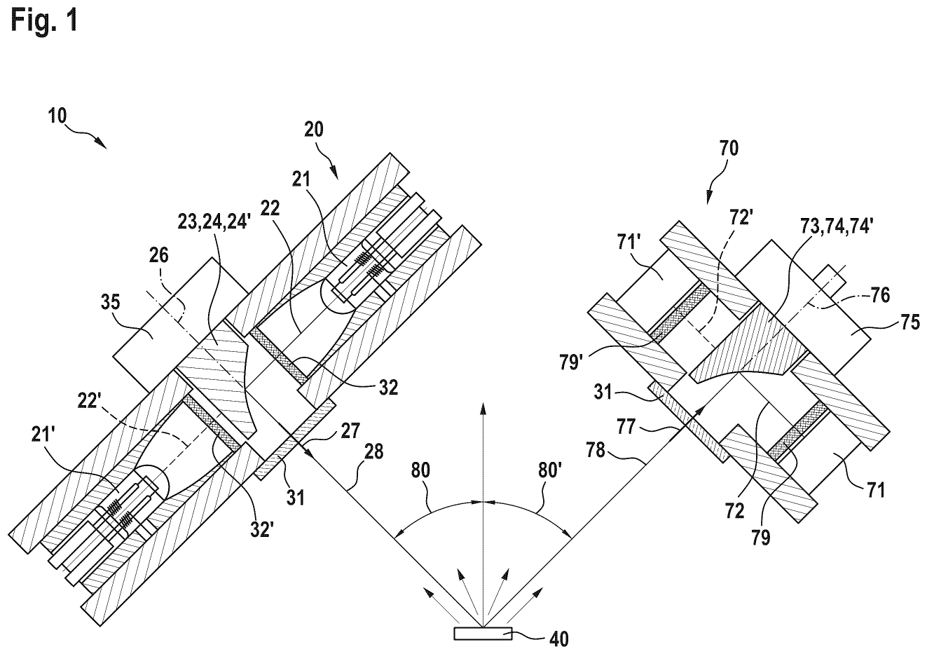

FIG. 1 shows a schematic sectional illustration of an apparatus 10 for examining a material sample 40 by means of fluorescence spectroscopy. The apparatus 10 comprises an illumination device 20 for generating the electromagnetic radiation and a detection device 70 for capturing the electromagnetic radiation emanating from the material sample 40. The illumination device 20 is tilted vis-à-vis the material sample 40 at an angle of incidence 80, for example 45°, and so the radiation 28 emanating from the illumination device 20 is incident on the material sample 40 at the angle of incidence 80. The detection device 70 is also inclined vis-à-vis the material sample 40 such that the intensity of the radiation 78 emitted by the material sample 40 is measured at an angle 80′.

The illumination device 20 comprises two radiation sources 21, 21′ in the form of halogen lamps that are provided with different wavelength-selective filters 32, 32′, whereby the emanating radiation 22, 22′ has different spectral properties. The two radiation sources 21, 21′ are arranged diametrically opposite one another such that their respective optical axes are aligned flush with one another. A deflection element 23 arranged in the beam path between the two radiation sources 22, 22′ serves to selectively steer the beams 22 of the first radiation source 21 or the beams 22′ of the second radiation sources 21′ onto the material sample 40. The deflection element 23 comprises a mirror 24, a concave mirror 24′ in this example, which may be rotated about an axis of rotation 26 that is perpendicular to the propagation direction of the beams 22, 22′.

In FIG. 1, the mirror 24 is in a position in which the radiation 22 from the first radiation source 21 is deflected with the aid of the mirror 24 and focused onto the material sample 40, while the radiation 22′ from the second radiation source 21′ is blocked by the deflection element 23. With the aid of the mirror 24, the radiation 21 from the first radiation source 21 is reflected into a propagation direction 27 that extends parallel—and collinearly in the present example—to the axis of rotation 26 of the deflection element 23. With the aid of a drive unit 35, the mirror 24 may be rotated through 180° from the position shown in FIG. 1 such that radiation 22′ from the second radiation source 21′ reaches the material sample 40, while the radiation 22 from the first radiation source 21 is blocked by the deflection element 23. In an alternative to the halogen lamps shown in FIG. 1, e.g. LEDs with a narrow spectral emission range may be used as radiation sources 21, 21′. In addition to the two halogen lamps, further radiation sources may be provided, which are preferably arranged on a great circle around the axis of rotation 26 of the deflection element 23.

The detection device 70 comprises two detectors 71, 71′ that are arranged diametrically opposite one another in the example of FIG. 1 such that their respective optical axes are aligned flush with one another. The two detectors 71, 71′ serve to measure the intensity of a radiation 78, which is incident on the detection device 70 in a direction of incidence 78, in different spectral ranges. To this end, use can be made of detectors 71, 71′ that inherently measure in different spectral ranges. In an alternative, use can be made of detectors 71, 71′ with an identical construction and a broad spectral sensitivity range that have been provided with different wavelength-selective filters 79, 79′ such that the radiation 78 is filtered in wavelength-specific fashion before it reaches the detectors 71, 71′.

Arranged between the two detectors 71, 71′ is a deflection element 73, with the aid of which a radiation 78 incident on the detection device 70 may be selectively steered onto one of the two detectors 71, 71′. The deflection element 73 comprises a mirror 74, a concave mirror 74′ in this example, which may be rotated about an axis of rotation 76 that is parallel to the incident radiation 78. A drive unit 75 is provided for rotating and positioning the mirror 74. In FIG. 1, the mirror 74 is in a position in which the radiation 78 emitted by the material sample 40 is focused via the mirror 74 onto the detector 71 (beam 72), while the second detector 71′ is shielded from the radiation 78 by the deflection element 73. A rotation of the mirror 74 through 180° steers the radiation 78 onto the second detector 71′ (beam 72′), while the first detector 71 is now shielded. In this way—by rotating the mirror 74—it is possible to use the detectors 71, 71′ to measure the intensity of the radiation 78 in different wavelength ranges. In addition to the detectors 71, 71′ shown in FIG. 1, even more detectors may be present, said further detectors being arranged in a great circle in a plane perpendicular to the axis of rotation 76 of the mirror 74. A drive unit 75 is provided for the positionally accurate rotation of the mirror.

The illumination device 20 and the detection device 70 are sealed from the surroundings by way of observation windows 31, for example sapphire windows, in order to suppress the ingress of dust and other contamination into the interior.

Advantageously, the wavelength-selective filters 32, 32′ of the illumination device 20 and the wavelength-selective filters 79, 79′ of the detection device are matched to one another in pairs so that the material sample 40 can be examined in two different spectral ranges without apparatus-based outlay, simply by rotating the mirrors 24, 74. Furthermore, a synchronized rotation of the two mirrors 24, 74 allows switching back and forth between the two different spectral measurement regions in quick temporal succession. In this case, the mirrors 24, 74 can be rotated continuously or incrementally. Thus, a continuous rotation of the mirrors 24, 74 allows radiation from the one or the other radiation source 21, 21′ to be steered onto the material sample 40 at regular time intervals and be detected wavelength-selectively in synchronized fashion by means of the detectors 71, 71′. In an alternative, the mirrors 24, 74 may be rotated in positioning fashion.

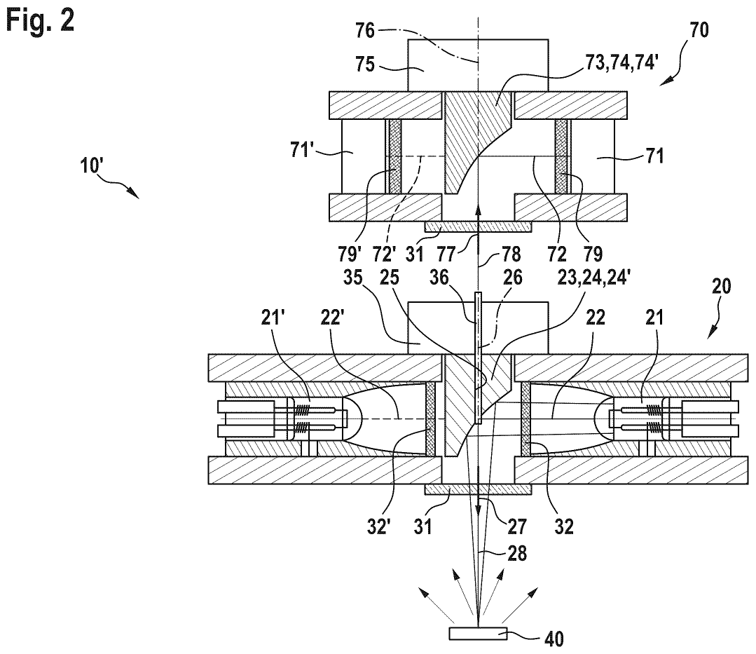

FIG. 2 shows a further apparatus 10′ for examining a material sample 40 with the aid of the illumination device 20 and the detection device 70, both of which are arranged flush and perpendicular to the material sample 40 in this example. The deflection element 23 of the illumination device 20 is provided with an opening 25 for receiving a light-guiding rod 36, by means of which a radiation reflected off the material sample 40 in the direction of incidence 27 can be transmitted through the deflection element 23 in the direction of the detection device 70. Using the illumination device 20, the material sample 40 is selectively or temporally alternately illuminated with radiation from the radiation source 21 or the radiation source 21′. The radiation 78 reflected off the material sample 40 in the direction of incidence 27 is guided through the deflection element 23 of the illumination device 20′ by means of a light-guiding rod 36 and is incident on the detection device 70, in which the radiation 78 is selectively or temporally alternately steered onto the detector 71 or the detector 71′. Should measurements in different spectral ranges be performed in quick alternation, the movements of the deflection elements 23, 73 in the illumination device 20′ and in the detection device 70 are advantageously synchronized in such a way that for a given radiation 22, 22′ in the detection device, the detector 71, 71′ in each case corresponding to the spectral range of this radiation 22, 22′ is enabled.

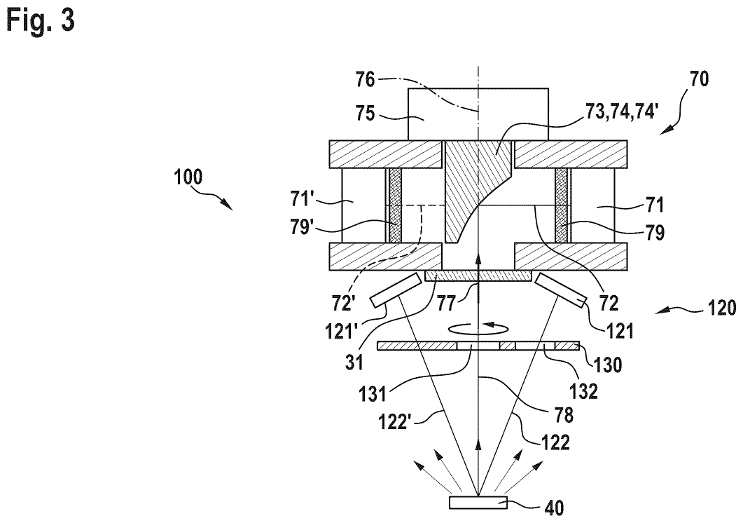

FIG. 3 shows an example of an apparatus 100 according to the invention, in which the detection device 70 substantially corresponds to the detection device shown in FIGS. 1 and 2. The illumination device 120 comprises a plurality of LEDs 121, 121′ with different spectral properties, which are arranged on a great circle in a ring around the material sample 40 such that the radiation 122, 122′ of said LEDs is aligned with the material sample 40. The material sample 40 is impinged upon with radiation at different wavelengths by an alternating switch-on and switch-off of these LEDs 121, 121′. The detection device 70 comprises detectors 71, 71′ whose spectral properties are matched to the spectra of the LEDs 121, 121′.

The alternating switching of the LEDs 121, 121′ can be achieved with the aid of a rotatable disk 130 in particular. The disk 130 has a central cutout 131 for the radiation 78 emanating from the material sample 40. Furthermore, a lateral cutout 132 is provided on the disk 130 and it allows the radiation from in each case one of the LEDs (the LED 121 in the present case) to be incident on the material sample 40. The angular position of the disk 130 is synchronized with the angular position of the mirror 74 in the interior of the detection device 70. In this way, the material sample 40 may be successively irradiated by different LEDs, and via the mirror 74 a measurement of the radiation emitted by the material sample 40 may be performed at the same time by the detector 71 assigned to this LED. In this case, the disk 130 may be electrically or mechanically linked to the drive unit 75 of the mirror 74.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An apparatus for examining a material sample via electromagnetic radiation, the apparatus comprising:
an illumination device to generate the electromagnetic radiation, the illumination device comprising at least two radiation sources, radiation of which being adapted to be selectively directed at the material sample; and
a detection device having at least two detectors to capture an electromagnetic radiation emanating from the material sample, the detection device comprising a deflection element via which the radiation emanating from the material sample is adapted to be selectively steered onto one of the detectors,
wherein the deflection element of the detection device comprises a mirror via which the radiation emanating from the material sample is adapted to be selectively steered onto one of the detectors, and
wherein the mirror rotatable about an axis that extends substantially perpendicular to optical axes of the detectors.

2. The apparatus as claimed in claim 1, wherein the at least two of the radiation sources have substantially identical structures.

3. The apparatus as claimed in claim 1, wherein the at least two of the radiation sources have different structures.

4. The apparatus as claimed in claim 1, wherein the at least two radiation sources are LED diodes.

5. The apparatus as claimed in claim 1, wherein the illumination device comprises a rotatable disk which is provided with cutouts and via which radiation from one of the radiation sources is adapted to be selectively steered onto the material sample.

6. The apparatus as claimed in claim 5, wherein the respective angular position of the disk of the illumination device is adapted to be synchronized with a respective position of the deflection element of the detection unit.

7. The apparatus as claimed in claim 1, wherein the illumination device comprises a deflection element via which radiation from one of the radiation sources is adapted to be selectively steered onto the material sample.

8. The apparatus as claimed in claim 7, wherein the deflection element of the illumination device has beam-shaping properties.

9. The apparatus as claimed in claim 7, wherein the deflection element of the illumination device comprises a mirror via which radiation from one of the radiation sources is selectively guided onto the material sample.

10. The apparatus as claimed in claim 7, wherein the deflection element is rotatable about an axis that is substantially parallel to a propagation direction of the deflected radiation.

11. The apparatus as claimed in claim 7, wherein the deflection element has an opening for the passage of electromagnetic radiation.

12. The apparatus as claimed in claim 11, wherein a light-guiding rod is arranged in the region of the opening.

13. The apparatus as claimed in claim 7, wherein respective settings of the deflection element of the illumination device and of the deflection element of the detection unit are synchronizable.

14. The apparatus as claimed in claim 1, wherein the deflection element of the detection device has beam-shaping properties.

15. The apparatus as claimed in claim 1, wherein the mirror is a concave mirror.
